(19) United States
(12) Patent Application Publication
(10) Pub. No.: US 2010/0238301 A1
(43) Pub. Date: Sep. 23, 2010

(54) COLOR CONTROLLING DEVICE, METHOD OF GENERATING COLOR CONTROLLING METHOD, AND METHOD OF GENERATING COLOR REPRODUCING DEVICE

(75) Inventor: Takayoshi KOJIMA, Azumino (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/725,022

(22) Filed: Mar. 16, 2010

(30) Foreign Application Priority Data
Mar. 23, 2009 (JP) 2009-070692

(51) Int. Cl. H04N 5/225

(52) U.S. Cl. 348/207.1; 348/E05.024

(57) ABSTRACT

Provided is a color controlling device, including a captured image data acquiring section that acquires captured image data obtained by capturing a plurality of targets, a color measuring section that acquires color measurement data obtained by measuring the colors of a plurality of targets, a first converting section that performs a first conversion including grayscale conversion for the captured image data and acquires first color data in a predetermined color space, a second converting section that performs a second conversion for the color measurement data and acquires second color data in a predetermined color space, and a modifying section that optimizes the first conversion executed by the first converting section based on a color difference between the first color data and the second color data, and weights.

### BACKGROUND

1. Technical Field

The present invention relates to a color reproducing method for input data.

2. Related Art

In the related art, there are disclosed various techniques for realizing the reproduction of colors as desired by users. For example, there is disclosed a technique for realizing color reproduction by using a color difference between a value obtained by measuring the color of a target color stored in a color chart by using a colorimeter and a value from a color chart obtained through an input device (for example, JP-A-2005-101828).

Furthermore, in case of the color reproduction technique described above, when a value acquired from a specific target was desired to be strongly reflected, the value acquired from the specific target was weighted and the degree of reflection was changed.

When the target is subjected to weighting, first, a weight is arbitrarily set for each value, the set weight is changed while referring a specific evaluated value, and a weight that optimizes the evaluated value is determined. Such a process is generally realized manually, and requires trial and error until an optimizing weight is set.

### SUMMARY

An advantage of some aspects of the invention is that it provides a color controlling device, a method of generating a color controlling method, and a method of generating a color reproducing device capable of generating a color reproducing method with accuracy and stability during color reproduction while performing weighting.

According to an aspect of the invention, there is provided a color controlling device including a captured image data acquiring section that acquires captured image data obtained by capturing a plurality of targets, a color measuring section that acquires color measurement data obtained by measuring the colors of a plurality of targets, a first converting section that performs a first conversion including grayscale conversion for the captured image data and acquires first color data in a predetermined color space, a second converting section that performs a second conversion for the color measurement data and acquires second color data in a predetermined color space, a weight setting section that performs weighting to a plurality of targets based on the first conversion, and a modifying section that optimizes the first conversion executed by the first converting section based on a color difference between the first color data and the second color data and the weights. In the color controlling device, when the modified first conversion is not optimized, the modifying section modifies the first conversion, and repeats a process of acquiring the first color data by the first converting section by using the modified first conversion plural times until the first conversion is optimized.

In the color controlling device configured as above, with respect to captured image data acquired by the captured image data acquiring section, the first converting section performs the first conversion including the grayscale conversion and acquires the first color data in the predetermined color space, and with respect to the color measurement data that the color measuring section acquired by measuring the colors, the second converting section performs the second conversion and acquires the second color data in the predetermined color space. In addition, the weighting setting section performs weighting to the plurality of targets based on the characteristics of the first color data. Furthermore, when the first conversion executed by the first converting section is optimized based on the difference in the first color data and the second color data and the weighting, the modifying section modifies the first conversion if the modified first conversion is not optimized, and repeats the process of acquiring the first color data by the first converting section by using the modified first conversion plural times until the first conversion is optimized.

For this reason, since the first conversion is optimized in a state where the weight is given to the targets, it is possible to optimally execute the weighting corresponding to the modification even when the first conversion is modified. In addition, it is possible to complete the process in the device, and to improve the accuracy of color reproduction in comparison to a case where a color reproducing method is adjusted manually.

According to the above aspect of the invention, as a technique of setting a target for performing weighting by the weight setting section, there is provided a color controlling device where the weight setting section performs heavy weighting so as to strongly reflect a target having a relatively large value obtained by dividing a difference in output grayscale values by a difference in input grayscale values before and after the first conversion, and performs light weighting so as to weakly reflect a target having a relatively small value obtained by dividing a difference in output grayscale values by a difference in input grayscale values before and after the first conversion.

In the color controlling device configured as above, as a specific example of determining a value obtained by dividing a difference of the output grayscale values by a difference of the input grayscale values, it is possible to generate a converting method which takes brightness changes into consideration.

Furthermore, according to the above aspect of the invention, there is provided a color controlling device where the weight setting section performs weighting by using a value obtained by differentiating the output grayscale value with the input grayscale value.

In the color controlling device configured as above, it is possible to compute a value in a simple manner with a calculating method using a differential value.

Furthermore, according to the above aspect of the invention, there is provided a color controlling device where the weight setting section performs weighting so as to strongly reflect a target having a relatively large second value obtained by dividing a difference in first values, which are obtained by dividing a difference in output grayscale values by a difference in input grayscale values before and after the first conversion, by a difference in input grayscale values, and performs weighting so as to weakly reflect a target having the relatively small second value.

In addition, the weight setting section performs weighting by using a value obtained by a second differential of the output grayscale value with the input grayscale value.

Furthermore, as an example of a technique with which the modifying section optimizes the first conversion, the modifying section optimizes the first conversion so that the color difference is minimized.

In the color controlling device configured as above, it is possible to generate a converting method in which a color difference of captured image data is minimized.

According to another aspect of the invention, there is provided a method of generating a color controlling method including acquiring captured image data for acquiring captured image data obtained by capturing a plurality of targets, measuring colors for acquiring color measurement data obtained by measuring the colors of a plurality of targets, first conversion for performing a first conversion including grayscale conversion for the captured image data and acquiring first color data in a predetermined color space, second conversion for performing a second conversion for the color measurement data and acquiring second color data in a predetermined color space, weight-setting for performing weighting to a plurality of targets based on the first conversion, and modifying for optimizing the first conversion executed in the first conversion based on a color difference between the first color data and the second color data and the weights. In the method of generating color controlling method, when the modified first conversion is not optimized, the modifying process modifies the first conversion, and repeats a process of acquiring the first color data in the first conversion process by using the modified first conversion plural times until the first conversion is optimized.

Furthermore, the invention can be applied to a technique of generating a color reproducing device using the generated converting method. To that end, according to still another aspect of the invention, there is provided a method of generating a color reproducing device that performs color reproduction for input data. The device includes a captured image data acquiring unit that acquires captured image data obtained by capturing a plurality of targets, a color measuring unit that acquires color measurement data obtained by measuring the colors of a plurality of targets, a first converting unit that performs a first conversion including grayscale conversion for the captured image data and acquires first color data in a predetermined color space, a second converting unit that performs a second conversion for the color measurement data and acquires second color data in a predetermined color space, a weight setting unit that performs weighting to a plurality of targets based on the first conversion, a modifying unit that optimizes the first conversion executed by the first converting unit based on a color difference between the first color data and the second color data and the weights, and a converting function inputting unit that inputs the optimized first conversion to the color reproducing device. In the method of the invention, when the modified first conversion is not optimized, the modifying unit modifies the first conversion, and repeats a process of acquiring the first color data by the first converting unit by using the modified first conversion plural times until the first conversion is optimized.

### BRIEF DESCRIPTION OF THE DRAWINGS

The invention will be described with reference to the accompanying drawings, wherein like numbers reference like elements.

FIG. 1 is a block diagram illustrating a structure of a color controlling device as an example.

FIG. 2 is a diagram illustrating a method of generating a color reproduction parameter in a color controlling device according to an embodiment of the invention.

FIG. 3 is a flowchart illustrating a process executed by a calculating section with a color reproduction parameter generating program.

FIG. 4 is a flowchart illustrating details of a process executed in step S120 of FIG. 3.

FIG. 5 is a graph illustrating a contrast converted by 1D-LUT as an example.

FIG. 6 is a flowchart illustrating details of a process executed by the calculating section in step S140 of FIG. 3.

FIG. 7 is a graph illustrating a technique of determining whether a value obtained by capturing a patch is a weighted object or not.

FIG. 8 is a diagram illustrating a color reproduction parameter generating technique according to a second embodiment.

FIG. 9 is a flowchart illustrating a process executed by a calculating section with a color reproduction parameter generating program according to the second embodiment.

### DESCRIPTION OF EXEMPLARY EMBODIMENTS

Hereinafter, exemplary embodiments of the invention will be described with reference to accompanying drawings following the order shown below.

1. First embodiment
1.1. Regarding a color controlling device
1.2. The configuration of a digital camera
1.3. The configuration of a PC
1.4. A colorimeter and a color chart
1.5. A color reproduction parameter generating method
2. Second embodiment
3. Other embodiments

### 1. First Embodiment

### 1.1. Regarding a Color Controlling Device

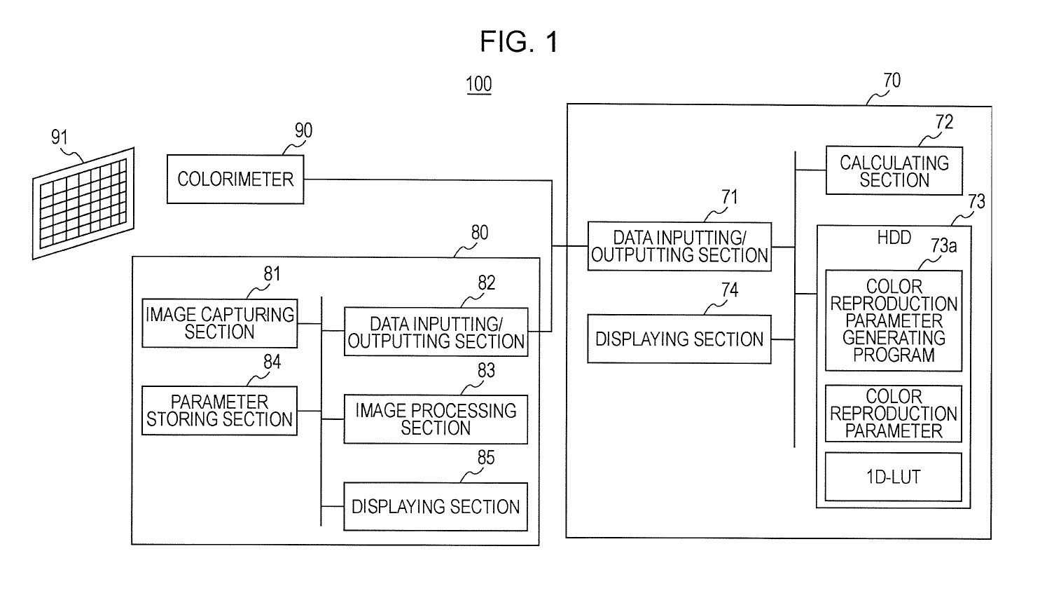

FIG. 1 is a block diagram illustrating a structure of a color controlling device as an example. In a color controlling device 100 shown in FIG. 1, a process of generating a color reproduction parameter of a color reproducing device (captured image data acquiring section) such as a digital camera is described as an example.

The color controlling device 100 generates a color reproduction parameter, which enables a digital camera 80 to perform color reproduction, with a personal computer (hereinafter, referred to as a “PC”) 70, and outputs the generated color reproduction parameter to the digital camera 80. At this point, the PC 70 optimizes and sets the color reproduction parameter by using an output value that the digital camera 80 acquired by capturing a color chart 91, and a color measurement value that a colorimeter 90 acquired by measuring the colors of the color chart 91.

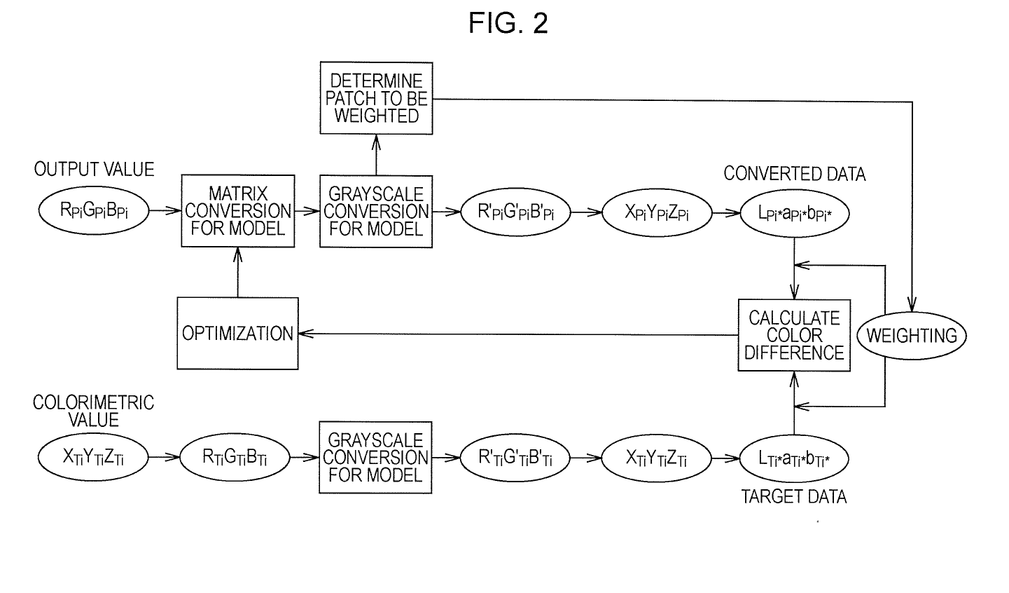

FIG. 2 is a diagram illustrating a method of generating a color reproduction parameter in the color controlling device 100 according to an embodiment of the invention. The process shown in FIG. 2 is executed within the PC 70. First, the color measurement value, which is obtained by the colorimeter 90 measuring the colors of the color chart 91, and the output value of an RGB color system, which is obtained by the digital camera 80 capturing the color chart 91, are input to the PC 70. The PC 70 performs color processing and grayscale conversion to the output value, which is input thereto, and then converts the resulting value into converted data on a uniform color space (L*a*b space). In addition, the PC 70 performs grayscale conversion to the color measurement value and then converts the resulting value into target data on the uniform color space. Furthermore, the PC 70 calculates a color difference between both of the values and optimizes a color reproduction parameter based on the calculated color difference. Here, the target data refers to a target color value to be set in the digital camera 80 in order to realize a color reproduction characteristic that a user desires.

Furthermore, in the color controlling device 100, in the course of generating a color reproduction parameter, weighting is performed for the output value obtained such that the digital camera 80 captures a predetermined patch of the color chart 91 and the color reproduction parameter is generated while the weight is considered. For this reason, since the weight is set to an appropriate patch of the color chart 91 in the course of generating the color reproduction parameter, it is possible to execute weighting optimally, and thereby to enhance reproduction accuracy of the color reproduction parameter. Hereinafter, the color controlling device 100 according to the invention will be described in detail.

### 1.2. The Configuration of a Digital Camera

The configuration of the digital camera 80 will be described. The digital camera 80 is provided with an image capturing section 81, an image processing section 83 for developing RAW image data captured by the image capturing section 81, a parameter storing section 84 for storing the color reproduction parameter and the like that the image processing section 83 refers in order to develop the RAW image data, and a data inputting/outputting section 82 for exchanging data with the PC 70. Furthermore, the digital camera 80 can display an image being captured on a displaying section 85 provided therein.

The image capturing section 81 is provided with an optical system including a photographing lens, an aperture, and the like, and an image sensor including a charge coupled device (CCD), and performs A/D conversion to analog data according to brightness of an object formed as an image on a light receiving surface of the CCD to output the RAW image data.

The data inputting/outputting section 82 transmits and receives the RAW image data output by the image capturing section 81, developed data output by the image processing section 83, the color reproduction parameter that the image processing section 83 refers when performing color reproduction, and the like to/from the PC 70.

The parameter storing section 84 retains the color reproduction parameter acquired from the PC 70 via the data inputting/outputting section 82. Here, examples of the color reproduction parameter include various parameters for performing white balance (WB) adjustment, auto exposure (AE), and a conversion matrix (3×3 matrix) for correcting spectral characteristics of the image capturing section 81. Furthermore, in the parameter storing section 84, a 1D-LUT for correcting a contrast characteristic of an output image is stored in addition to the color reproduction parameter. Moreover, as the conversion matrix, there are various matrixes other than the 3×3 matrix, but the present embodiment will be described based on an example using the 3×3 matrix.

The 1D-LUT is used in grayscale conversion for improving, for example, visual quality of developed data. As an example thereof, the 1D-LUT performs gamma correction for an output value to correct a contrast characteristic.

The image processing section 83 develops the RAW image data by using various parameters stored in the parameter storing section 84. Specifically, the image processing section 83 performs demosaic interpolation, WB adjustment, AE, matrix conversion, and gamma correction for the RAW image data using each of the parameters, and then converts the data into developed data in the form of a joint photographic experts group (JPEG), a tagged image file format (TIFF), or the like.

With the configuration described above, the digital camera 80 generates the developed data from the image processing section 83 based on the RAW image data of an object image captured in the image capturing section 81, and outputs the developed data to an output device via the data inputting/outputting section 82.

1.3. The Configuration of a PC

Next, the configuration of the PC 70 will be described. The PC 70 is provided with the data inputting/outputting section 71, the calculating section 72, an HDD 73, and a displaying section 74. In addition, the HDD 73 stores data and various kinds of software for realizing predetermined functions of the PC 70, and executes specific processes with the calculating section 72 developing and executing data or the software in a RAM (not shown in the drawing) on the basis of a predetermined operating system.

The data inputting/outputting section 71 transmits and receives the RAW image data, the developed data, the color reproduction parameter, the target data and the like by communicating with the digital camera 80 and the colorimeter 90. Specifically, the data inputting/outputting section 71 communicates via a data inputting/outputting section 82 of the digital camera 80. Furthermore, the data inputting/outputting section 71 may be further provided with a function of an input device which receives input from a user. The input device is, for example, a keyboard, a mouse, or the like.

The HDD 73 stores a color reproduction parameter generating program 73a for generating the color reproduction parameter of the digital camera 80, the default color reproduction parameter, and the like. In addition, the calculating section 72 is constituted by a CPU and a RAM, and can generate the color reproduction parameter by developing and executing the color reproduction parameter generating program 73a stored in the HDD 73 in the RAM.

### 1.4. A Colorimeter and a Color Chart

The color chart 91 is configured to be arranged with patches 1 to N with the aim of determination or analysis of color reproducibility. The patches 1 to N cover different color tones and grayscales. Examples of the color chart 91 include the Munsell color chart and the Macbeth color chart. In addition, the colorimeter 90 measures colors of each of the patches 1 to N in the color chart 91, and outputs color measurement values (X_{Ti}, Y_{Ti}, and Z_{Ti}) defined in the XYZ color system (i represents the patches 1 to N). Furthermore, if the PC 70 is configured to retain the color measurement value obtained by measuring the colors of the color chart 91 by the colorimeter 90 in advance, the colorimeter 90 may be excluded from the color controlling device 100.

### 1.5. A Color Reproduction Parameter Generating Method

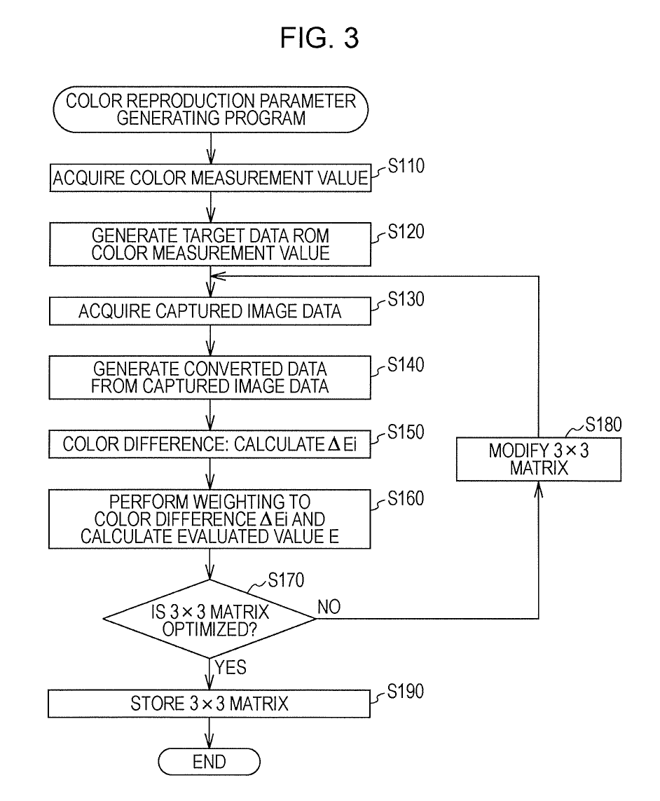

FIG. 3 is a flowchart illustrating a process executed by the calculating section 72 with the color reproduction parameter generating program. The flowchart of FIG. 3 shows procedures that a 3×3 matrix is optimized in order to perform matrix conversion within the color reproduction parameter. At this point, moreover, the calculating section 72 optimizes the 3×3 matrix while weighting a region having a high grayscale value in an output value obtained by the digital camera 80 capturing the color chart 91. Hereinafter, steps of generating the color reproduction parameter in the PC 70 will be described with reference to FIG. 3.

As shown in FIG. 3, processes by the color reproduction parameter generating program 73a are largely divided into a step of generating target data (L_{Ti}*, a_{Ti}*, and b_{Ti}*) in the L*a*b color space from a color measurement value output by the colorimeter 90 measuring the colors of the patches 1 to N of the color chart 91 (first conversion section: steps S110 and S120), a step of generating converted data (L_{Pi}*, a_{Pi}*, and b_{Pi}*) in the L*a*b color space from an output value output by the digital camera 80 capturing the color chart (second conversion section: steps S130 and S140), and a step of calculating a color difference: ΔEi from the target data and the converted data and optimizing a 3×3 matrix so that the evaluated value: E created based on the calculated color difference: ΔEi is minimized (modifying section: steps S140 to S170, i represents the patches 1 to N).

Hereinafter, steps of generating the target data will be described. When the color measurement values (X_{Ti}, Y_{Ti}, and Z_{Ti}) of the XYZ color system are received from the colorimeter 90 through the data inputting/outputting section 71 of the PC 10 (step S110), the calculating section 72 generates the target data (L_{Ti}*, a_{Ti}*, and b_{Ti}*) defined in the L*a*b color space while performing the gamma correction to the color measurement values (step S120).

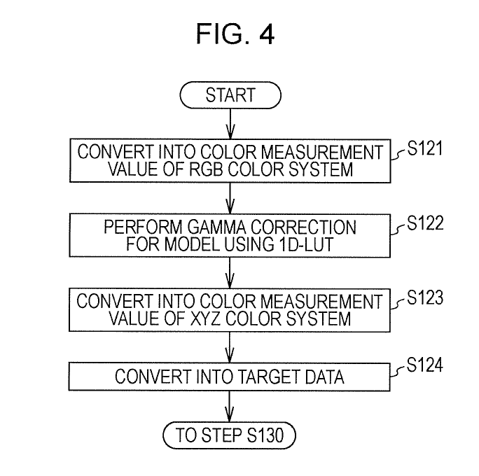

FIG. 4 is a flowchart illustrating details of a process executed in step S120 shown in FIG. 3. When the color measurement values (X_{Ti}, Y_{Ti}, and Z_{Ti}) are received from the colorimeter 90, the calculating section 72 first converts the color measurement values into second color measurement values (R_{Ti}, G_{Ti}, and B_{Ti}) of an RGB color space (step S121). Specifically, the calculating section 72 converts the color measurement values of the XYZ color system into the color measurement values of the RGB color space by using the following (Equation 1) shown below.

$$\begin{matrix}Expression 1 & \\ [ \begin{matrix}R \\ G \\ B\end{matrix} ] = {[ \begin{matrix}2.7689 & 1.7517 & 1.1302 \\ 1.0000 & 4.5907 & 0.0601 \\ 0.0000 & 0.0565 & 5.5943\end{matrix} ]}^{- 1} [ \begin{matrix}X \\ Y \\ Z\end{matrix} ] & ( 1 )\end{matrix}$$

Next, the calculating section 72 performs the gamma correction by using the 1D-LUT for the converted color measurement values, and calculates third color measurement values (R′_{Ti}, G′_{Ti}, and B′_{Ti}) having improved visual quality (step S122). In the gamma correction using the 1D-LUT, the contrast of the color measurement values are mainly corrected according to the characteristics of an output apparatus such as a printer.

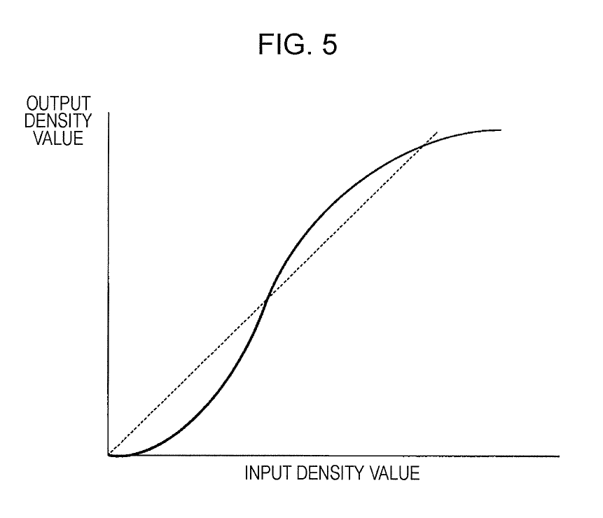

FIG. 5 is a diagram illustrating the contrast converted by the 1D-LUT as an example. In FIG. 5, the dotted line represents input/output characteristics in the case of γ:1. A density conversion curve converted by the 1D-LUT forms the corresponding relationship of grayscales values, which are of an input value and an output value, so as to be non-linear in the lower grayscale value side and the higher grayscale value side. Furthermore, the contrast characteristic converted by the 1D-LUT shown in FIG. 5 is an example, and may be set depending on the output characteristic of a device to which the digital camera 80 is connected and different design concepts of each manufacturer, and therefore is not limited thereto.

The calculating section 72 converts the color measurement values corrected in step S122 again into a fourth color measurement values (X′_{Ti}, Y′_{Ti}, and Z′_{Ti}) defined in the XYZ color system (step S123). Specifically, the calculating section 72 converts the color measurement values (R′_{Ti}, G′_{Ti}, and B′_{Ti}) that have been defined in the RGB color space into the color measurement values (X′_{Ti}, Y′_{Ti}, and Z′_{Ti}) defined in the XYZ color system by using Equation (2) shown below.

$$\begin{matrix}Expression 2 & \\ [ \begin{matrix}X \\ Y \\ Z\end{matrix} ] = [ \begin{matrix}2.7689 & 1.7517 & 1.1302 \\ 1.0000 & 4.5907 & 0.0601 \\ 0.0000 & 0.0565 & 5.5943\end{matrix} ] [ \begin{matrix}R \\ G \\ B\end{matrix} ] & ( 2 )\end{matrix}$$

The calculating section 72 converts the converted color measurement values into target data defined in the L*a*b* color space (step S124). Specifically, the calculating section 72 converts the color measurement values of the XYZ color system into the target data (L_{Ti}*, a_{Ti}*, and b_{Ti}*) defined in the L*a*b* color space by using Equation (3) shown below.

$$\begin{matrix}Expression 3 & \\ {L}^{*} = 116 {( \frac{Y}{{Y}_{n}} )}^{1 / 3} - 16 Y / {Y}_{n} > 0.008856 \\ {L}^{*} = 903.29 ( \frac{Y}{{Y}_{n}} ) Y / {Y}_{n} \leq 0.008856 \\ {a}^{*} = 500 ( {( \frac{X}{{X}_{n}} )}^{1 / 3} - {( \frac{Y}{{Y}_{n}} )}^{1 / 3} ) \\ {b}^{*} = 200 ( {( \frac{Y}{{Y}_{n}} )}^{1 / 3} - {( \frac{Z}{{Z}_{n}} )}^{1 / 3} ) & ( 3 )\end{matrix}$$

Where Xn, Yn, and Zn are values of white points in the XYZ color system.

The calculating section 72 executes processes from steps S121 to 5124 for all the patches 1 to N arranged in the color chart 91, and creates the target data (L_{Ti}*, a_{Ti}*, and b_{Ti}*) corresponding to each of the patches 1 to N. So far, the process for generating the target data (L_{Ti}*, a_{Ti}*, and b_{Ti}*) defined in the L*a*b* color space has been described.

Next, a process of generating the converted data will be described. When the output values (R_{Pi}, G_{Pi}, and B_{Pi}) output by the digital camera 80 after capturing the color chart 91 are received through the data inputting/outputting section 71 (step S130), the calculating section 72 generates converted data (L_{Pi}*, a_{Pi}*, and b_{Pi}*) defined in the L*a*b* color space from the output values (step S140).

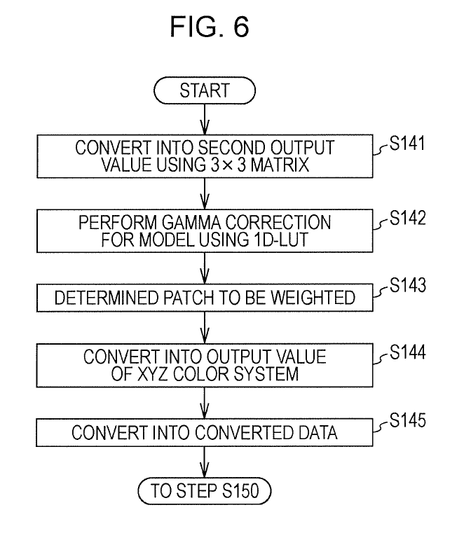

FIG. 6 is a flowchart illustrating details of the process executed by the calculating section 72 in step S140 of FIG. 3. The calculating section 72 converts the output values (R_{Pi}, G_{Pi}, and B_{Pi}) into second output values (R′_{Pi}, G′_{Pi}, and B′_{Pi}) by using default 3×3 matrix for correcting the spectral characteristic of the image capturing section 81 (step S141). Here, the default 3×3 matrix is calculated by using the least-square method.

Furthermore, the calculating section 72 generates third output values (R″_{Pi}, G″_{Pi}, and B″_{Pi}) by performing the gamma correction for the converted output values using the 1D-LUT (step S142). Moreover, the 1D-LUT used herein is the same as the 1D-LUT used for the color measurement values in step S122, and as the 1D-LUT used in the digital camera 80 when the RAW image data are developed. In addition, the calculating section 72 generates the third output values (R″_{Pi}, G″_{Pi}, and B″_{Pi}) for all the patches 1 to N of the color chart 91.

The calculating section 72 performs weighting corresponding to each of the patches (step S143). In the present embodiment, the weighting is performed so that the output values (R′_{Ti}, G′_{Ti}, and B′_{Ti}) having high input/output characteristics are heavily reflected in the density conversion curve of the third output values (R″_{Pi}, G″_{Pi}, and B″_{Pi}) as an example.

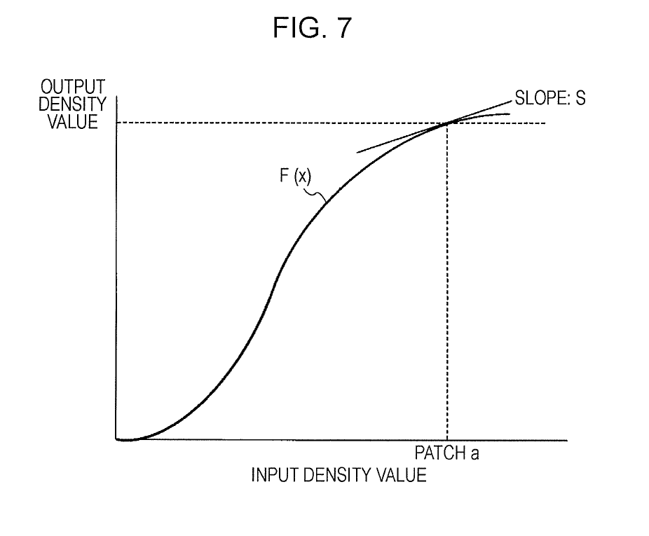

FIG. 7 is a graph illustrating a technique of performing weighting for a value obtained by capturing a patch. Here, the horizontal axis represents the second output values, the vertical axis represents the third output values, and the curve represents the third output values obtained by converting a certain second output value. In the density conversion curve shown in FIG. 7, the slope S of the tangent line in the third output values (R″_{Pa}, G″_{Pa}, and B″_{Pa}) obtained by capturing the patch a is simply calculated by a differential value obtained by differentiating a formula F(x) that approximately represents the density conversion curve, and calculated by Equation (4) shown below.

Expression 4

S=F′(a) (4)

Where F(x) represents an approximate formula of the density conversion value, and a represents a value of the patch a in the color chart.

In addition, the calculating section 72 compares the slope S of the density conversion curve to a threshold value that has been set in advance, and a heavier weight is given to the third output values having slopes greater than the threshold value than is given to the third output values having slopes smaller than the threshold value.

However, the formula F(x) that approximately represents the density conversion curve is not used for the calculation, but a formula S={f(β)−f(α)}/{β−α} may be used for the calculation even though it may have lower accuracy.

The calculating section 72 converts the third output values (R″_{Pi}, G″_{Pi}, and B″_{Pi}) of the RGB color space into fourth output values (X_{Pi}, Y_{Pi}, and Z_{Pi}) of the XYZ color system (step S144). Specifically, the calculating section 72 converts the output values of the RGB color space into the output values (X_{Pi}, Y_{Pi}, and Z_{Pi}) of the XYZ color system by using Equation (2) shown above.

The calculating section 72 generates the converted data (Lₚᵢ*, a_{Pi}*, and b_{Pi}*) defined in the L*a*b* color space from the converted output values (step S145). Specifically, the calculating section 72 converts the fourth output values into the converted data (L_{Pi}*, a_{Pi}*, and b_{Pi}*) by using Equation (3) shown above.

The calculating section 72 generates converted data corresponding to each of the patches 1 to N by performing the processes from steps S144 to S145 for all of the patches 1 to N arranged in the color chart 91, and determines a patch to be weighted. So far, the process of generating the converted data defined in the L*a*b* color space has been described.

A process of optimizing the color reproduction parameter (3×3 matrix) will be described using the target data and the converted data. The calculating section 72 calculates a color difference ΔEi between the target data (L_{Ti}*, a_{Ti}*, and b_{Ti}*) and the converted data (L_{Pi}*, a_{Pi}*, and b_{Pi}*) (step S150). Here, the color difference ΔEi represents a perceptual difference in colors quantitatively, and is calculated by using Equation (5) shown below in the L*a*b* color space.

Expression 5

ΔEᵢ=\sqrt{(ΔL*)²+(Δa*)²+(Δb*)²} (5)

The calculating section 72 creates an evaluated value E based on the calculated color difference ΔEi (step S160). The evaluated value E is a value which sums up the color differences ΔEi while giving a weight to a patch specified in step S143 out of all the patches 1 to N (N is an integer) in the color chart 91, and is calculated by using Equation (6) shown below.

$$\begin{matrix}Expression 6 & \\ E = {\sum }_{N} Wi Δ {E}_{i} & ( 6 )\end{matrix}$$

Where Wi represents a weight given to patches 1 to N.

The calculating section 72 optimizes the 3×3 matrix so that the evaluated value E calculated in step S160 is minimized (steps S170 and S180). Specifically, the calculating section 72 stores the calculated evaluated value E in a RAM or the like, then converts it by adding a modified value to each of the values of the default 3×3 matrix, and calculates the evaluated value E again by using the converted 3×3 matrix (steps S130 to S180). A series of processes from steps S130 to 5180 is repeated until the evaluated value E is minimized in step S170, and the 3×3 matrix at that point is an optimized value. Furthermore, it may also be applicable that the processes are repeated until the evaluated value E is equal to or less than a predetermined threshold value E_{TH} in step S170.

As an example of a technique for obtaining a modified value in the 3×3 matrix, the calculating section 72 converts the 3×3 matrix by using the Newton-Raphson method. Furthermore, optimization of the 3×3 matrix for minimizing the evaluated value E by using the Newton-Raphson method is an example, and other optimization techniques such as the regula falsi method, the simplex method, or the like may be used.

When the 3×3 matrix is optimized in step S170, the calculating section 72 temporarily stores the optimized 3×3 matrix and the 1D-LUT used in step S142 in the RAM or the like, and then outputs to the digital camera 80 via the data inputting/outputting section 71 (step S190). The digital camera 80 receives the optimized 3×3 matrix through the data inputting/outputting section 82 and stores the matrix in the parameter storing section 84. For this reason, the digital camera 80 develops the RAW image data by using the 3×3 matrix. So far, a process of generating the color reproduction parameter according to the first embodiment has been described.

### 2. Second Embodiment

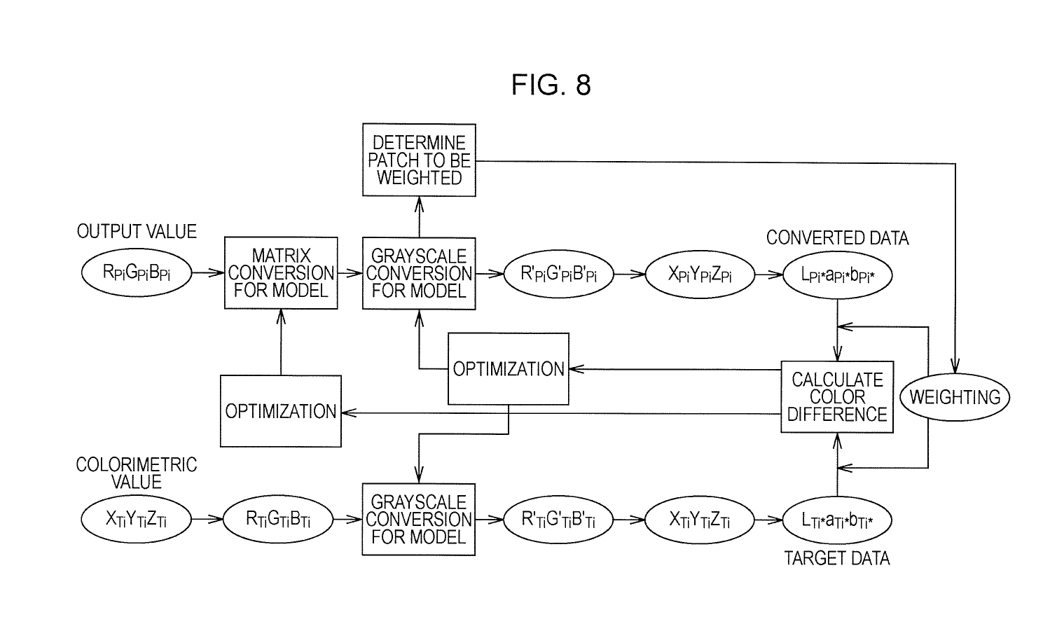

FIG. 8 is a diagram illustrating a method of generating the color reproduction parameter according to the second embodiment. In the method of generating the color reproduction parameter according to the second embodiment, the 1D-LUT is optimized by using the target data (L_{Ti}*, a_{Ti}*, and b_{Ti}*) and the converted data (L_{Pi}*, a_{Pi}*, and b_{Pi}*), and in addition to the 3×3 matrix. For this reason, it is possible to more flexibly optimize the color reproduction parameter and the 1D-LUT.

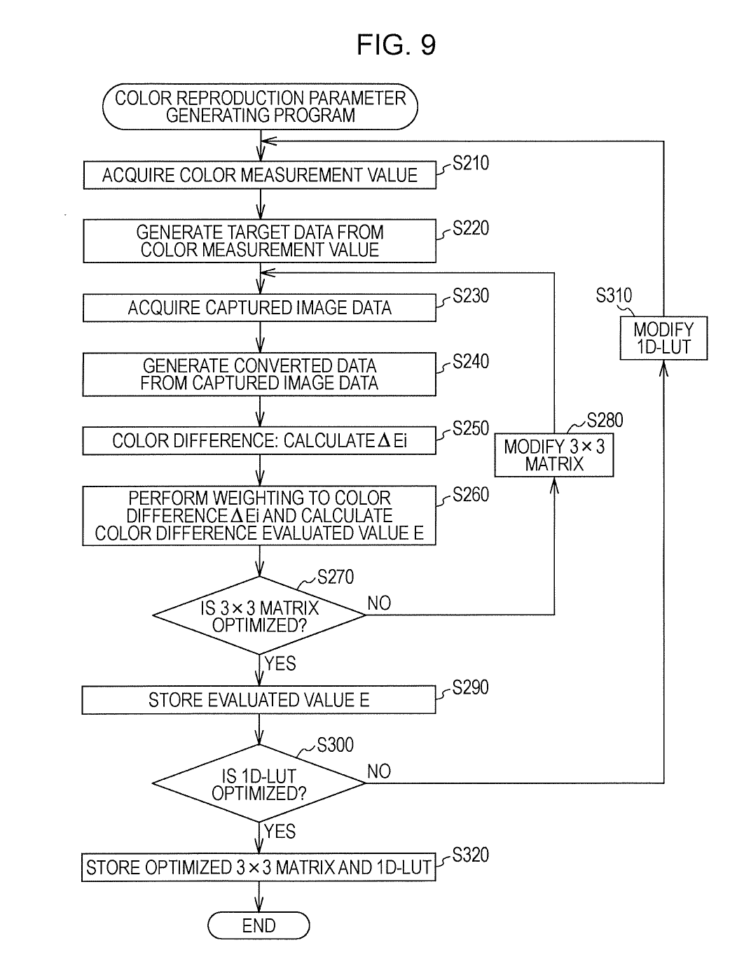

FIG. 9 is a flowchart illustrating a process executed by the calculating section 72 with the color reproduction parameter generating program 73a according to the second embodiment. Furthermore, in the second embodiment, only the color reproduction parameter generating program 73a has been changed, and other components constituting the color controlling device 100 are the same as those in the first embodiment.

When the color measurement values (X_{Ti}, Y_{Ti}, and Z_{Ti}) of the XYZ color system are received from the colorimeter 90 through the data inputting/outputting section 71 of the PC 70 (step S210), the calculating section 72 converts the color measurement values into target data (L_{Ti}, a_{Ti}*, and b_{Ti}*) defined in the L*a*b* color space (step S220). At this point, the calculating section 72 performs the gamma correction to the color measurement values by the default 1D-LUT, after converting the values into the color measurement values of the RGB color system. Here, the default 1D-LUT is a 1D-LUT that has not been optimized by the calculating section 72.

Next, when the output values (R_{Pi}, G_{Pi}, and B_{Pi}) output by the digital camera 80 by capturing the color chart 91 are received through the data inputting/outputting section 71 (step S230), the calculating section 72 performs matrix conversion for the output values and correction by using the default 1D-LUT, and then converts the data into the converted data (L_{Pi}*, a_{Pi}*, and b_{Pi}*) defined in the L*a*b* color space (step S240). At this point, the calculating section 72 determines a target to be weighted out of the patches 1 to N of the color chart 91 as in the first embodiment.

The calculating section 72 calculates a color difference ΔEi between the target data (L_{Ti}*, a_{Ti}*, and b_{Ti}*) and the converted data (L_{Pi}*, a_{Pi}*, and b_{Pi}*) (step S250). In the same manner, the calculating section 72 sums up the color difference ΔEi with all the patches 1 to N in the color chart 91, and performs weighting for the color difference ΔEi determined as a target to be weighted to calculate a evaluated value E (step S260). Furthermore, the calculating section 72 optimizes the 3×3 matrix so that the calculated evaluated value E is minimized in each of the patches in the color chart 91 with the default 1D-LUT (steps S210 to S280). In addition, it is also applicable that the optimization is performed so that the evaluated value E is equal to or less than a predetermined threshold value E_{TH1}.

In step S270, when the 3×3 matrix is optimized, the calculating section 72 temporarily stores the optimized 3×3 matrix and the evaluated value E at that point in the RAM or the like (step S290).

Furthermore, the calculating section 72 modifies each parameter of 1D-LUT so that the brightness of a value converted by the 1D-LUT is changed (step S310), and optimizes the 3×3 matrix again. For example, the calculating section 72 multiplies the 1D-LUT used for the color measurement values and the output values by a certain gain g to make the change in the brightness remarkable.

Furthermore, the calculating section 72 returns to step S210 to generate the target data and the converted data by using the 1D-LUT after the conversion. At this point, by the change in the brightness in the 1D-LUT, there is a case where the slopes of the third output values (R″_{Pi}, G″_{Pi}, and B″_{Pi}) are changed. For this reason, the calculating section 72 performs weighting for the patches from the generated output values (R″_{Pi}, G″_{Pi}, and B″_{Pi}) again.

In addition, the calculating section 72 calculates the color difference ΔEi in each of the patches 1 to N by using the generated target data and the converted data, and calculates the evaluated value E by weighting and summing up the color difference ΔEi. Furthermore, the 3×3 matrix is optimized so that the evaluated value E is minimized (step S230 to S280). It may be possible that the evaluated value E is optimized to be equal to or less than a predetermined threshold value E_{TH2}. After that, the calculating section 72 temporarily stores the 1D-LUT after the conversion, the optimized 3×3 matrix, and the evaluated value E at that point in the RAM or the like (step S280).

The processes of steps S210 to S310 described above are repeated until the change in all the gains g set for the 1D-LUT in advance has been executed, and the calculating section 72 stores a combination of the 3×3 matrix and the 1D-LUT at the point when the processes are executed with all the gains g so that the stored evaluated value E is minimized, and outputs the 3×3 matrix and the 1D-LUT to the digital camera 80 (step S310). The digital camera 80 receives the 3×3 matrix and the 1D-LUT after optimization through the data inputting/outputting section 82, and stores them in the parameter storing section 84. With the configuration, the digital camera 80 executes a developing process of the RAW image data including a converting process by using the optimized 3×3 matrix and the 1D-LUT. So far, the process of generating the color reproduction parameter according to the second embodiment has been described.

### 3. Other Embodiments

When the weighting is performed in step S143 and step S250, the weighting may be heavily performed if a change in the slope of the density conversion curve is great. In this case, for a first value which is a second differential value obtained from the second differential of the Formula F(x) that approximately represents the density conversion curve or a value obtained by dividing a difference in output grayscale values by a difference in input grayscale values, the weighting is performed based on a second value obtained by dividing a difference in the first values by a difference in the input grayscale values.

The color reproduction parameter may optimize a 3D-LUT when the 3D-LUT is used to replace the combination of the 3×3 matrix and the 1D-LUT.

The sequence of using the 3×3 matrix and the 1D-LUT is not limited to the above sequence, and may be applied to a case where the correction is performed by using the 1D-LUT and then the developing process is performed by using the 3×3 matrix.

The color space to be used is not limited to the embodiments above, and other color spaces such as L*u*v*, HLS or the like may be used.

The digital camera in the embodiments is an example to described a device where a color reproduction parameter is set, and an object where the color reproduction parameter is generated may be display devices such as a smart viewer. In addition, it is possible that the smart viewer, other than a PC, is configured to generate the color reproduction parameter.

Furthermore, it is needless to say that the invention is not limited to the embodiments described above. In other words, appropriately modifying and applying combinations of members and structures which are substitutable with each other as described in the embodiments above, modifying the calculation to a mathematically equivalent value, appropriately substituting members and structures in the related art with members and structures disclosed in the above embodiments which are substitutable with each other, and modifying combinations thereof even though it is not disclosed in the embodiments above, and appropriately substituting members and structures that a skilled person can assume to be a substitute of the members and structures disclosed in the embodiments above based on the related art even though it is not disclosed in the embodiments above, and modifying and applying combinations thereof are disclosed as an example of the invention.

The entire disclosure of Japanese Patent Application No. 2009-070691, filed Mar. 23, 2009 is incorporated by reference herein.

The entire disclosure of Japanese Patent Application No. 2009-070692, filed Mar. 23, 2009 is incorporated by reference herein.

What is claimed is:

1. A color controlling device, comprising:
a captured image data acquiring section that acquires captured image data obtained by capturing a plurality of targets;
a color measuring section that acquires color measurement data obtained by measuring the colors of a plurality of targets;
a first converting section that performs a first conversion including grayscale conversion for the captured image data and acquires first color data in a predetermined color space;
a second converting section that performs a second conversion for the color measurement data and acquires second color data in a predetermined color space;
a weight setting section that performs weighting to a plurality of targets based on the first conversion; and
a modifying section that optimizes the first conversion executed by the first converting section based on the first color data, the second color data, and the weights;
wherein, when the modified first conversion is not optimized, the modifying section modifies the first conversion, and repeats a process of acquiring the first color data by the first converting section by using the modified first conversion plural times until the first conversion is optimized.

2. The color controlling device according to claim 1, wherein the weight setting section performs heavy weighting so as to strongly reflect a target having a relatively large value obtained by dividing a difference in output grayscale values by a difference in input grayscale values before and after the first conversion, and performs light weighting so as to weakly reflect a target having a relatively small value obtained by dividing a difference in output grayscale values by a difference in input grayscale values before and after the first conversion.

3. The color controlling device according to claim 2, wherein the weight setting section performs weighting by using a value obtained by differentiating an output grayscale value with an input grayscale value.

4. The color controlling device according to claim 1, wherein the weight setting section performs heavy weighting so as to strongly reflect a target having a relatively large second value obtained by dividing a difference in first values, which are obtained by dividing a difference in output grayscale values by a difference in input grayscale values before and after the first conversion, by a difference in input grayscale values, and performs light weighting so as to weakly reflect a target having the relatively small second value.

5. The color controlling device according to claim 2, wherein the weight setting section performs weighting by using a value obtained by a second differential of an output grayscale value with an input grayscale value.

6. The color controlling device according to claim 1, wherein the modifying section optimizes the first conversion so that the color difference is minimized.

7. A method of generating a color controlling method, comprising:
acquiring captured image data by capturing a plurality of targets;
measuring colors for acquiring color measurement data obtained by measuring the colors of a plurality of targets;
first conversion for performing a first conversion including grayscale conversion for the captured image data and acquiring first color data in a predetermined color space;
second conversion for performing a second conversion for the color measurement data and acquiring second color data in a predetermined color space;
weight-setting for performing weighting to a plurality of targets based on the first conversion; and
modifying for optimizing the first conversion executed in the first conversion based on the first color data, the second color data, and the weights;
wherein, when the modified first conversion is not optimized, the modifying process modifies the first conversion, and repeats a process of acquiring the first color data in the first conversion process by using the modified first conversion plural times until the first conversion is optimized.

8. A method of generating a color reproducing device that performs color reproduction for input data, the method comprising;
acquiring captured image data obtained by capturing a plurality of targets;
acquiring color measurement data obtained by measuring the colors of a plurality of targets;
performing a first conversion including grayscale conversion for the captured image data and acquires first color data in a predetermined color space;
performing a second conversion for the color measurement data and acquires second color data in a predetermined color space;
weighting to a plurality of targets based on the first conversion;
optimizing the first conversion executed based on the first color data, the second color data, and the weights; and
inputting the optimized first conversion to the color reproducing device;
wherein, when the first conversion is not optimized, the modifying process modifies the first conversion, and repeats a process of modifying the first color data by using the modified first conversion plural times until the first conversion is optimized.
